(19) United States
(12) Patent Application Publication
(10) Pub. No.: US 2025/0353603 A1
(43) Pub. Date: Nov. 20, 2025

(54) ELECTRIC AIRCRAFT ENGINE AND COMPRESSOR FOR ENGINE RETROFIT

(71) Applicant: Pratt & Whitney Canada Corp., Longueuil (CA)

(72) Inventors: Michel Bousquet, Longueuil (CA); Kevin Nguyen, Montreal (CA)

(21) Appl. No.: 19/285,079

(22) Filed: Jul. 30, 2025

Related U.S. Application Data
(62) Division of application No. 18/207,791, filed on Jun. 9, 2023.

(51) Int. Cl. B64D 27/34; B64D 13/06; B64D 15/00; B64D 27/31; B64D 35/026

(52) U.S. Cl. CPC B64D 27/34; B64D 13/06; B64D 15/00; B64D 27/31; B64D 35/026; B64D 2013/0603

(57) ABSTRACT

An electric aircraft engine includes an electric motor driving a propulsor. A power source powers the electric motor. An electric compressor supplies compressed air. A nacelle surrounds the electric motor, the power source and the electric compressor. An aircraft and a method are also disclosed.

### CROSS-REFERENCE TO RELATED APPLICATIONS

This application is a divisional of U.S. patent application Ser. No. 18/207,791 filed on Jun. 9, 2023.

### BACKGROUND

This application relates to an electric aircraft engine that includes an electric compressor within its nacelle such that it can be retrofit to existing gas turbine engine powered aircraft.

Aircraft typically have one or more gas turbine engines. The gas turbine engines provide propulsion through a propulsor such as a propeller or fan. Typically, the propulsor delivers air into a compressor section where the air is compressed and then delivered into a combustor. In the combustor the compressed air is mixed with fuel and ignited. Products of this combustion pass downstream over turbine rotors, driving them to rotate.

As can be appreciated, aircraft include a number of complex systems. Several require compressed air. As one example there are anti-ice systems which receive hot compressed air to deliver air outwardly to melt or shed ice. Such a system may be mounted in the wing of the aircraft. Another system is an environmental control system which provides conditioned air into an aircraft cabin, the cockpit, storage areas, and for other functions.

In current aircraft, the gas turbine engine compressor typically has one or two taps which tap compressed air to be delivered to the anti-ice system and the ECS system.

The compressed air taps are connected into the aircraft fuselage and wing through connections extending through a strut or mount that attaches the engine to the aircraft.

There are efforts underway to replace gas turbine engines with electric powered engines or a hybrid of the two. This will reduce fuel burn, emissions and potentially noise.

Future aircraft systems may be designed to incorporate such electric engines and use a source of compressed air other than a gas turbine engine compressor. However, retrofitting current aircraft with an electric engine would raise challenges as there would be no way to supply the compressed air to systems such as the anti-ice system and ECS without reworking the system.

### SUMMARY

An electric aircraft engine includes an electric motor driving a propulsor. A power source powers the electric motor. An electric compressor supplies compressed air. A nacelle surrounds the electric motor, the power source and the electric compressor. An aircraft having such an engine is also disclosed.

A method of retrofitting an existing aircraft includes the steps of providing an aircraft having a gas turbine engine with a gas turbine engine compressor. There is at least one compressed air tap for supplying compressed air from the gas turbine engine compressor to an anti-ice system and to an environmental control system through compressed air connections. The method includes removing the gas turbine engine including disconnecting the gas turbine engine compressor from the compressed air connections to the anti-ice system and the environmental control system. The method then mounts an electric engine to the aircraft. The electric engine includes an electric motor driving a propulsor. A power source powers the electric motor. An electric compressor supplies compressed air, and a nacelle surrounds the electric motor, the power source and the electric compressor. The mounting step includes connecting the electric compressor to the compressed air connections to supply compressed air to the anti-ice system and to the environmental control system.

These and other features will be best understood from the following drawings and specification, the following is a brief description.

### BRIEF DESCRIPTION OF THE DRAWINGS

FIG. 1 shows a prior art aircraft.

FIG. 2 shows a detail of the prior art aircraft.

FIG. 3 shows an aircraft engine according to this disclosure connecting into an aircraft.

FIG. 4A shows a first step in retrofitting the FIG. 2 aircraft with the FIG. 3 engine.

FIG. 4B shows a subsequent step in retrofitting the FIG. 3 engine onto the prior art aircraft.

FIG. 5 shows another engine embodiment.

### DETAILED DESCRIPTION

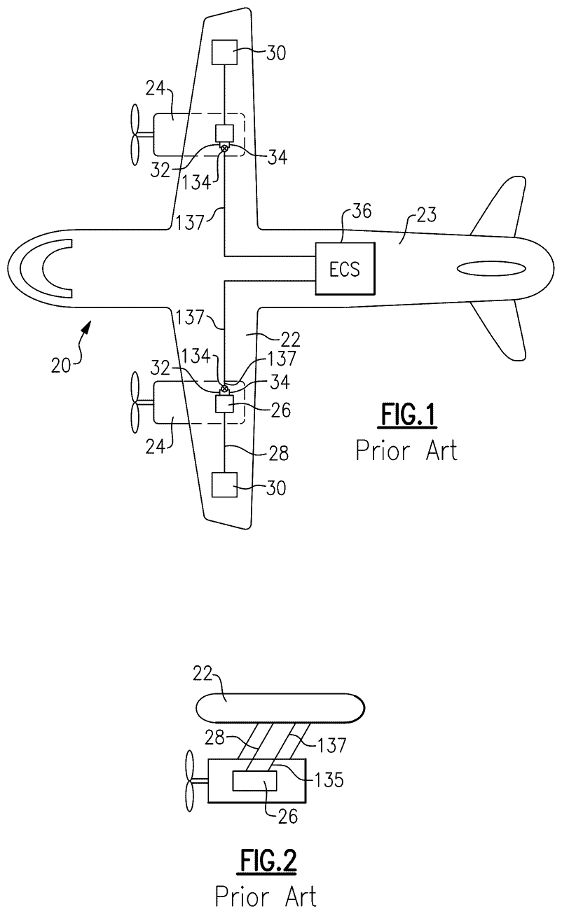

A current aircraft 20 is illustrated highly schematically in FIG. 1. Wings 22 are shown as is a fuselage 23. Engines 24 are shown mounted beneath the wings 22. It should be understood that in some applications the engines could be mounted to the fuselage 23, and such aircraft would also benefit from this disclosure. The prior art engines 24 are gas turbine engines having a compressor 26 as described above. The compressor 26 is shown delivering air through tap 28 to an anti-ice system 30. Compressor 26 also has a low pressure tap 24 and a high pressure tap 34 communicating to a valve 134 that sends air to a connection 137 leading to an ECS system 36.

While two engines 24 are illustrated on aircraft 20, this disclosure extends to aircraft having a single engine or more than two engines.

Systems 30 and 36 are shown schematically. In practice both are very complex systems. It may be desirable to retrofit an electric engine to replace engines 24, as explained below. Due to the complexity of systems 30 and 36 it would be desirable to not replace or even modify systems 30 and 36 when retrofitting the engine. This disclosure facilitates this goal.

As shown in the prior art FIG. 2, the engines 24 are mounted to the wing 22 through a strut or pylon 40. The taps 28 and 137 extend through the pylon 40 as would the tap 28.

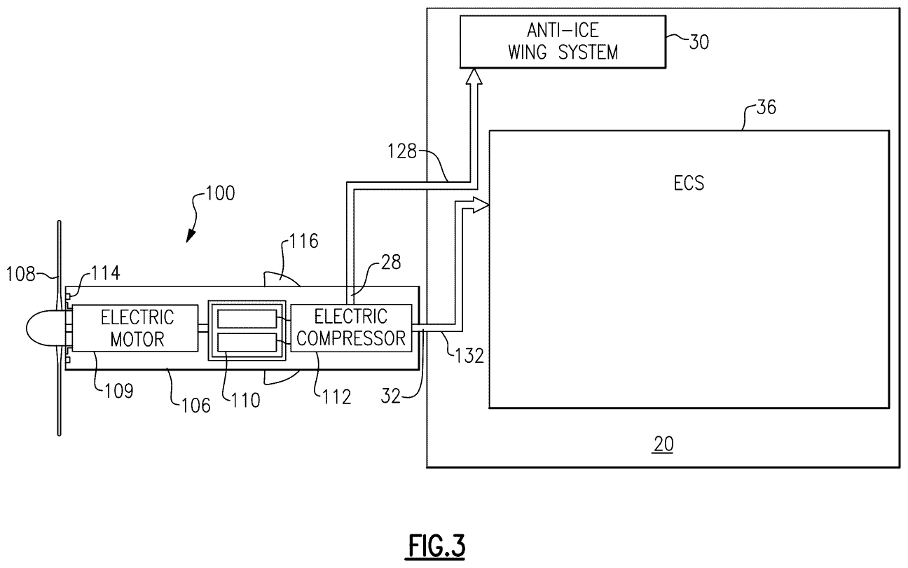

FIG. 3 shows an engine, and anti-ice and ECS systems under this disclosure. An electric engine 100 supplies air through a tap 28 to a connection 128 on aircraft 20 and then to an anti-ice system 30. A tap 32 delivers the air to a connection 132 on aircraft 20 and then to an ECS system 36.

The engine 100 includes an electric motor 109 driving propeller 108. Some power storage device 110 is utilized to power the electric motor 109. The power storage devices 110 may be batteries, fuel cells, ultracapacitors, or any other acceptable power storage device.

An electric compressor 112 is shown supplying compressed air to the taps 28 and 32. Taps 28 and 32 are connected to connections 128 and 132. The electric compressor 102 may also be powered by the power storage device 110. However, other power sources may drive the electric motor for compressor 112. Air is supplied to the electric compressor 112 through openings 114 in a nacelle 106. Alternatively, or in combination, an air scoop 116 is formed in nacelle 106. The air is compressed and delivered to the anti-ice system 30 and the ECS 36.

Notably, the electric compressor 112, electric motor 109 and power storage devices 110 are mounted within the nacelle 106. This has benefits when retrofitting an aircraft with an existing gas turbine to have engine 100.

Future aircraft that are to utilize electric engine will have their anti-ice system and environmental control system designed to received compressed air from a source other than a gas turbine engine compressor. However, it may be desirable to retrofit existing aircraft with such an electric engine 100. Although the anti-ice system 30 and the environmental control system 36 are shown as black boxes in fact they are very complex systems. It would be burdensome to redesign or replace these systems to receive an alternative source of compressed air. By utilizing this disclosure, once can work with both systems as existing on the aircraft being retrofit.

This will reduce the burden of having to make any such changes to those systems.

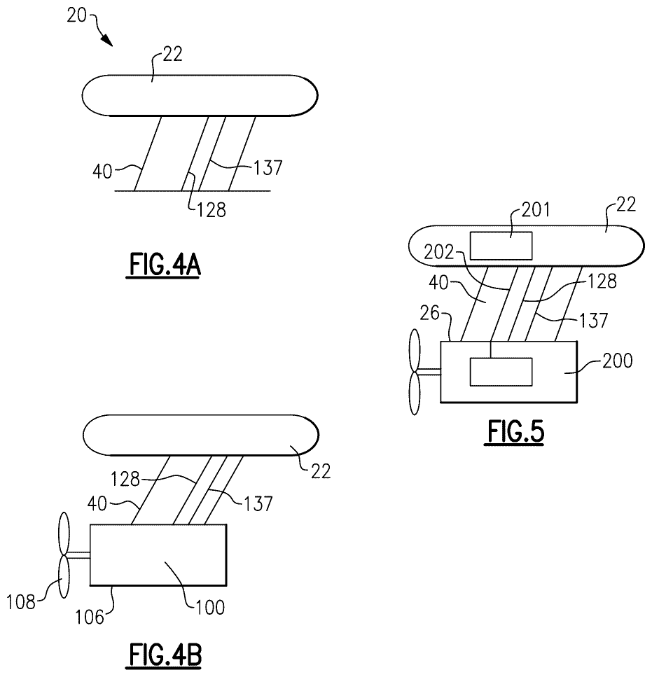

FIG. 4A shows a first step in retrofitting the aircraft 20. The existing gas turbine engines 24 are removed, leaving the strut 40 and connections 128, 132 and 134.

Next, as shown in FIG. 4B, an electric engine 100 is attached to the strut 40. Taps 28 and 32, such as shown in FIG. 3 are connected into the anti-ice system and ECS system through connections 128 and 132. The compressed air connections from the electric compressor 112 are now connected into the existing conduits 128 and 130 in the strut 40. One does not need two taps to the ECS system 36 as the compressor 112 can be ran at a constant speed no matter the power state of motor 109. Thus, the anti-ice system 30 and the ECS system 36 need not be modified in combination with retrofitting the aircraft with the electric engine.

FIG. 5 shows an alternative embodiment 200. Here there is not a power storage device within the nacelle 206. Rather, a bus bar 202 communicates electric power from a power storage device 201 which may be mounted on the aircraft, such as in wing 22.

An electric aircraft engine 100 under this disclosure could be said to include an electric motor 109 driving a propulsor 108. A source device 110 powers the electric motor 109. An electric compressor 112 supplies compressed air. A nacelle 106 surrounds the electric motor, the power source and the electric compressor.

In another embodiment according to the previous embodiment, the power source is a power storage device.

In another embodiment according to any of the previous embodiments, the power storage device also powers the electric compressor.

In another embodiment according to any of the previous embodiments, an air inlet communicates through the nacelle to the electric compressor.

In another embodiment according to any of the previous embodiments, the air inlet is provided by a scoop inlet in an outer peripheral surface of the nacelle.

In another embodiment according to any of the previous embodiments, the air inlet is formed in a forward face of the nacelle adjacent the propulsor.

In another embodiment according to any of the previous embodiments, the power storage device is at least one of a battery, a fuel cell and an ultracapacitor.

An aircraft 20 under this disclosure could be said to include a fuselage 23 and a pair of wings 22. An anti-ice system 30 is provided in at least one of the pair of wings and fuselage. The anti-ice system is operable to receive compressed air and deliver it to areas of the at least one of the pair of wings or fuselage to melt ice. Alternatively, the anti-ice system may deliver air to pressurize deicer boots which will shed ice from the wings. An environmental control system 36 receives compressed air and utilizes the compressed air within a cabin of the aircraft fuselage 23. An electric engine 100 is connected to at least one of the pair of wings and the fuselage through a pylon 40. The electric engine 100 includes an electric motor 109 driving a propulsor 108. A power storage device and a power source 110 powers the electric motor. An electric compressor 112 supplies compressed air. A nacelle 106 surrounds the electric motor, the power source and the electric compressor. Compressed air from the electric compressor is connected to pass outwardly of the nacelle 106 and to the anti-ice system 30 and to the environmental control system 36.

In another embodiment according to any of the previous embodiments, the power source is the power storage device that is also within the nacelle.

In another embodiment according to any of the previous embodiments, the power source is a bus bar receiving power from the power storage device and the power storage device is mounted in at least one of the fuselage and wing.

In another embodiment according to any of the previous embodiments, the power storage device also powers the electric compressor.

In another embodiment according to any of the previous embodiments, the power storage device is at least one of a battery, a fuel cell and an ultracapacitor.

In another embodiment according to any of the previous embodiments, an air inlet communicates through the nacelle to the electric compressor.

In another embodiment according to any of the previous embodiments, the air inlet is provided by a scoop inlet in an outer peripheral surface of a nacelle.

In another embodiment according to any of the previous embodiments, the air inlet is formed in a forward face of a nacelle adjacent the propulsor.

A method of retrofitting an existing aircraft under this disclosure could be said to include the steps of providing an aircraft 20 having a gas turbine engine 124 with a gas turbine engine compressor 26. There is at least one compressed air tap 28/32/34 for supplying compressed air from the gas turbine engine compressor to an anti-ice system 30 and to an environmental control system 36 through compressed air connections 128/132/134. The method includes removing the gas turbine engine, including disconnecting the gas turbine engine compressor from the compressed air connections anti-ice system and the environmental control system. The method then mounts an electric engine 100 to the aircraft. The electric engine includes an electric motor 109 driving a propulsor 108. A power storage device 110 powers the electric motor. An electric compressor 112 for supplying compressed air, and a nacelle surrounding the electric motor, the power storage device and the electric compressor. The mounting step includes connecting the electric compressor to the compressed air connections to supply compressed air to the anti-ice system and to the environmental control system.

In another embodiment according to any of the previous embodiments, prior to the removing step the gas turbine engine is attached to the aircraft through a pylon, and the electric engine is mounted to the pylon.

In another embodiment according to any of the previous embodiments, the power source is a power storage device that is also within the nacelle.

In another embodiment according to any of the previous embodiments, the power source is a bus bar receiving power from a power storage device mounted in at least one of the fuselage and wing.

In another embodiment according to any of the previous embodiments, the power storage device also powers the electric compressor.

Although embodiments have been disclosed, a worker of skill in this art would recognize that modifications would come within the scope of this disclosure. For that reason, the following claims should be studied to determine the true scope and content.

What is claimed is:

1. A method of retrofitting an existing aircraft comprising the steps of:
providing an aircraft, the aircraft having a gas turbine engine with a gas turbine engine compressor, and there being at least one compressed air tap for supplying compressed air from the gas turbine engine compressor to an anti-ice system and to an environmental control system through compressed air connections;
removing the gas turbine engine, the removing step including disconnecting the gas turbine engine compressor from the compressed air connections to the anti-ice system and the environmental control system;
mounting an electric engine to the aircraft, and the electric engine including an electric motor driving a propulsor, a power source for powering the electric motor, an electric compressor for supplying compressed air, and a nacelle surrounding said electric motor, said power source and said electric compressor; and
the mounting step including connecting the electric compressor to the compressed air connections to supply compressed air to the anti-ice system and to the environmental control system.

2. The method as set forth in claim 1, wherein prior to the removing step the gas turbine engine is attached to the aircraft through a pylon, and the electric engine is mounted to the pylon.

3. The method as set forth in claim 2, wherein the power source is a power storage device that is also within the nacelle.

4. The method as set forth in claim 2, wherein the power source is a bus bar receiving power from a power storage device mounted in at least one of the fuselage and wing.

5. The method as set forth in claim 2, wherein the power storage device also powers the electric compressor.

6. The method as set forth in claim 2, wherein an air inlet communicates through the nacelle to the electric compressor.

7. The method as set forth in claim 6, wherein the air inlet is provided by a scoop inlet in an outer peripheral surface of the nacelle.

8. The method as set forth in claim 6, wherein the air inlet is formed in a forward face of the nacelle adjacent the propulsor.

9. The method as set forth in claim 2, wherein the power storage device is at least one of a battery, a fuel cell and an ultracapacitor.

10. The method as set forth in claim 1, wherein the power source is a power storage device that is also within the nacelle.

11. The method as set forth in claim 1, wherein the power source is a bus bar receiving power from a power storage device mounted in at least one of the fuselage and wing.

12. The method as set forth in claim 1, wherein the power storage device also powers the electric compressor.

13. The method as set forth in claim 1, wherein an air inlet communicates through the nacelle to the electric compressor.

14. The method as set forth in claim 13, wherein the air inlet is provided by a scoop inlet in an outer peripheral surface of the nacelle.

15. The method as set forth in claim 13, wherein the air inlet is formed in a forward face of the nacelle adjacent the propulsor.

16. The method as set forth in claim 13, wherein the power storage device is at least one of a battery, a fuel cell and an ultracapacitor.

17. The method as set forth in claim 1, wherein the power storage device is at least one of a battery, a fuel cell and an ultracapacitor.

18. An aircraft comprising:
a fuselage and a pair of wings;
an anti-ice system provided in at least one of the pair of wings and fuselage, the anti-ice system operable to receive compressed air and deliver it to areas of the at least one of the pair of wings and fuselage to melt ice;
an environmental control system to receive compressed air and utilize the compressed air within a cabin of the aircraft fuselage;
an electric engine connected to at least one of the pair of wings and the fuselage through a pylon;
the electric engine including an electric motor driving a propulsor;
a power source for powering the electric motor;
an electric compressor for supplying compressed air;
a power storage device;
a nacelle surrounding said electric motor, said power source and said electric compressor; and
compressed air from the electric compressor connected to pass outwardly of the nacelle and to the anti-ice system and to the environmental control system.

19. The aircraft as set forth in claim 18, wherein the power source is the power storage device that is also within the nacelle.

20. The aircraft as set forth in claim 18, wherein the power source is a bus bar receiving power from the power storage device and the power storage device is mounted in at least one of the fuselage and wing.
